(19) United States
(12) Patent Application Publication
(10) Pub. No.: US 2009/0002141 A1
(43) Pub. Date: Jan. 1, 2009

(54) Visual device for vehicles in difficult climatic/environmental conditions

(76) Inventor: Tazio Rinaldi, Mantova (IT)

Correspondence Address: PYLE & PIONTEK;ATTN: THOMAS R. VIGIL, 221 N LASALLE STREET , ROOM 2036, ROOM 2036, CHICAGO, IL, 60601, US

(21) Appl. No.: 12/009,360

(22) Filed: Jan. 18, 2008

(30) Foreign Application Priority Data
Jul. 18, 2005 (IT) MN2005A000049

(51) Int. Cl. B60Q 1/00

(52) U.S. Cl. 340/425.5

(57) ABSTRACT

The invention relates to a visual device for vehicles in difficult climatic/environmental conditions of the type essentially comprising a thermal camera (2) installed on a vehicle and connected to a viewing means positioned in the interior thereof, by means of a connection cable. The visual device is designed to operate from a resting condition in which it provides inactive, with no image present on the viewing means, to an operative condition in which a driver sees what is happening ahead of his own vehicle.

### TECHNICAL FIELD

The present invention relates to a visual device for vehicles in difficult climatic/environmental conditions, particularly indicated to allow drivers a good view of the road in the presence of difficult conditions such as fog, smoke, storms or darkness.

### BACKGROUND ART

As it is known, many road accidents are caused by scarce visibility due to heavy storms, fog, of varying thickness or in banks, or darkness during the night time.

In particular, the most serious multiple-car pileups occur in the period of densest fog which reduces visibility dramatically. Limited visibility on the road though unfortunately, does not always correspond to drivers reducing the speed of their vehicles, and it often happens that drivers find themselves facing unexpected obstructions due to stationary vehicles or they run into thick fog banks and reduce the vehicle's speed all of a sudden. This behavior causes, on many occasions, accidents to be triggered and therefore, then, a series of rear-end collisions which end up involving dozens of vehicles, and blocking sections of major roads for many hours, leading to traffic jams and notable inconveniences and, unfortunately, often deaths and many casualties.

At the moment, vehicles are not equipped with safety devices designed to avert this hazard; in fact, normal fog-lights exist, which do not offer any reliability and cannot offer real help to those driving in scarce visibility conditions.

Nowadays the sector's attention regarding the prevention of accidents caused by fog is focused on the realization of active systems, i.e. those which emit their own light and are installed on the roads to delimit the carriageway, since the traditional systems, passive in style (orange cats' eyes), have always had a somewhat limited effectiveness due to the rapid attenuation of the ray of light reflected, or the sound bands located along the edge of the carriageway which, on contact with tires, emit noises which indicate to the driver that s/he is going off the carriageway but, at the same time, do not always allow the driver to recover his position in time.

A first type of active system has been utilized for detecting and signaling fog on the bridge over the river Po and in the adjacent stretches over a length or approximately 12.5 km.

After a first experiment with incandescent halogen lamps, the system was realized using LED lamps. The LEDs were red and green in color to obtain an orange color similar to that of cats' eyes. The system is equipped with fog sensors which activate the system and it is connected with the Operations Centre in Trento.

The LED system emits its own yellow light, which could be compared to that reflected by passive cats' eyes. In scarce visibility conditions, when the cats' eyes do not reflect the light, they are replaced by the lamps which will help the user to perceive the delimitation of the carriageway and the direction of travel. In fact, the LED system, with the presence of luminous points every 25 m, helps the user to perceive the intensity of the fog synthetically, according to the number of luminous points visible. In addition, the LED system is equipped with a luminosity emission regulation system for the lamps for better adjustment to the external lighting (day-night difference) and visibility conditions. In fact, the system envisages different ways in which they lamps can light up: lit up constantly, flashing, cascade effect with variable speeds. Furthermore, the detection system, present in the system, notifies the operations centre of the local visibility conditions objectively, independently of the sensitivity of a human operator.

The system illustrated, while helping drivers considerably, has brought to light a series of drawbacks.

A first drawback derives from the fact that they are costly systems requiring considerable work, both for their installation along the road and for maintenance.

A further drawback that emerged derives from the fact that it is not possible to provide all the roads with these devices, which means many zones remain, as a result, lacking in systems, and moreover, it sometimes happens that there are periods during which fog is present in places normally immune to this phenomenon, with the result that drivers, unaccustomed to driving in difficult conditions like these, are much more liable to cause or suffer accidents.

A further but not final drawback derives from the fact that a control centre is necessary with staff available 24 hours a day and consequent notable running costs.

A further, alternative system to the system illustrated earlier, utilizes a laser ray as an active luminous element.

The laser ray system is based on an emitter which generates a continuous line of red light with a wavelength of 635 nanometers which, in the presence of fog, through the effect of the refraction of the suspended droplets of water, creates a kind of luminous “tube”.

The experimental system (one kilometer in length) was realized at Nogarole Rocca station and was composed of 80 couples of laser emitters and receivers arranged, at a height of 1.10 m, along the left-hand side of each carriageway according to the direction of travel, with a space of 25 m between each one.

This system also brought diverse problems to light. In fact, the laser system emits a red light and can be mistaken for a vehicle brake light, leading the driver into possible errors of judgment.

A further problem emerged due to the fact that the laser proves less effective as it emits a thin continuous line which is only visible in the presence of fog (light reflected by the water particles present in the air), which means in the presence of other scarce visibility conditions, such as darkness, storms or smoke, it proves decidedly ineffective.

In addition to the points illustrated above, the LED lamp system is only switched on in the event of fog, when visibility is below a preset threshold, while the laser system, because of its operating principle and its low energy consumption, would remain on throughout the autumn-winter period.

On the other hand, the continuous functioning without automatic detecting also renders it valid for fog banks of a limited length, which might not be detected by the fog detection sensor.

A further problem brought to light by the laser system derives from the fact that the laser, characterized by a light emission concentrated in one point, requires a perfect alignment both to create a continuity of the optical line (composed of the various 25 m long segments) and for the emitter to correctly aim the ray at the receiver as is necessary to ensure the system returns the signal.

The return of the signal (necessary to prevent the ray disturbing drivers of transiting vehicles following collisions) envisages the deactivation of the laser emitter by the receiver in the event that the latter does not receive the light signal, thereby creating a discontinuity of the optical line.

During the experimental stage, a loss of alignment was observed so frequently between the transmitter and the receiver due, probably, to gusts of air or small knocks, that it was necessary to turn off the aforesaid automatic deactivation system.

As far as ordinary, extraordinary or preventive maintenance of the active equipment is concerned (electronic acquisition parts, control actuation, electrical panel and stabilizers or voltage regulators etc.), the systems illustrated have brought to light that: the LED system proves less dispersive in terms of intervention times and problem identification, and less dangerous as regards safety at work, since said equipment is housed in special cabins located in special lay-bys while the only parts found along the actual highway are the “passive” system parts, which are less delicate and subject to fewer breakdowns (cables, transformers); as for the laser system, the active parts are also found in the receiver and the transmitter and in this case interventions are required to be carried out on the road itself.

As a result of the above, it proves evident that less time is required for maintenance operations, in particular in identifying eventual breakdowns, with the LED lamp system.

But on the contrary, the LEDs need cleaning interventions due to impurities depositing on the transparent screen, which are, however, contemporaneous to the ordinary cleaning of passive cats' eyes.

The elements on the road (delineators, posts) frequently prove exposed to the risk of being damaged or knocked over by transiting vehicles leaving the carriageway, in which case the cost of the laser is, as mentioned earlier, much higher.

Finally, it should be noted that, in the LED system, the perception of the intensity of the blanket of fog thanks to the number of lamps visible becomes useless without a consequent adjustment of the speed by the driver.

A further system of preventing accidents due to fog, traffic or other causes, actuated on a stretch of the Brescia-Padua highway, consists in continuous traffic monitoring by means of combined-technology sensors deployed at strategic points, connected with variable message panels placed in proximity to the junction slip roads and the surrounding roads. The system is composed of five video cameras which consent direct surveillance of the events, while a supervisory subsystem receives all the data relating to the traffic and the apparatus' functionality, and regulates the inlet flow at the entry slip roads of the stretch of road concerned. Furthermore, the presence of video cameras, a certain number of which are assigned to video surveillance, permits automatic accident detection and direct data exchange with the urban traffic control system for signaling to the users by means of the variable message panels.

Through a network of variable frequency flashing lights positioned along the traffic divider, the aforementioned system aims to contribute significantly to reducing the risk of accidents.

Since the system's activation, three years ago, over 50 warnings have been launched by the system to alert drivers to critical traffic situations, fog or accidents. This has led to a perceptible reduction in hazardous situations, especially in the autumn and winter seasons. In particular; the system starts functioning even in the event of jams caused by excessive traffic.

Once operative, the radars and fog sensors integrated into the signaling posts positioned on the edges of the road will monitor the flow of traffic along the 20 km stretch of the ‘Serenissima’ highway near Garda Lake, between Sirmione and Sommacampagna. In fact, there are frequent accidents in this portion of the A4 highway. As soon as the system recognizes that a hazardous situation has occurred, the signaling lights start flashing. The distance between the activated flashing lights and the zone at risk varies depending on the traffic conditions and the highway characteristics. The same principle applies to a second stretch of the A4, also 20 km long, between Grisignano and Padova Est, where radars and fog sensors are positioned to monitor the effective meteorological and traffic conditions since this stretch of road is particularly subject to fog and accidents.

The heart of this warning and information system is constituted of the electronically-controlled flashing lights integrated into the signaling posts situated along the road or on the traffic divider. Low-frequency conductors connect the flashing lights directly to the Traffic Control Centre. When required, automatic accident detection programs activate the flashing lights along the road to alert drivers to situations in progress.

This signaling system, while proving efficacious, does not support drivers when driving, but simply alerts them to current hazardous situations. In fact, it happens that drivers already concentrating on driving in the fog do not always pay particular attention to the message panels, or if there is intense traffic, they are not always able to see the signal lights (flashing or otherwise) which means they run the risk of finding themselves involved in the accident already reported or causing one, in their turn, by braking suddenly following the warning.

A further signaling system, also of the luminous type, has been utilized in England in which “intelligent” cats' eyes were equipped with sensors which permit them to identify the presence of ice, rain and fog. But the intelligence of these devices lies in their capacity to communicate with each other using infrared rays; they can, in fact, be programmed so that they change color to alert drivers to the hazards identified by the cats' eyes found further ahead, along the road. Instead of using reflectors, these devices contain luminous diodes powered by solar energy. Even in adverse meteorological conditions, one hour of light is sufficient for the diodes to accumulate the energy necessary to function throughout the night. They are visible from a distance of 900 m and are programmed so that, in the event of fog, numerous diodes, arranged in a series, become luminous, thereby increasing the visibility of each stretch of road.

It is known that traditional cats' eyes are only visible from a distance of 80 meters, such distance being decidedly insufficient, for example, to warn drivers traveling at high speeds of the presence of a hazardous curve. The distance from which it is visible, in fact, remains the same, at both 50 and 110 km/h. The “intelligent” cats' eyes can be programmed in different ways. Instead of being always luminous, they can be set to switch on suddenly for a duration of four seconds, for example when another driver crosses and interrupts the infrared ray which allows communication with the adjacent cats' eyes. In this way, we are warned of the presence of a vehicle in front of us, by the creation of a kind of luminous trail. It is also possible to have the light points change color, to warn drivers that get too close to maintain a safe distance from the vehicle ahead. By means of a communication network based on mechanisms which alert drivers to road hazards, cats' eyes could provide information on the road conditions to the police traffic control centers. All these devices could contribute to saving human lives, even though drivers would first need to be taught how to use them and take them into account.

From what is stated above it can be deduced that the problem of road safety is widely recognized and there is a research program, which also exists at a European level, whose objective is to improve traffic safety and efficiency.

In fact, the topic of safety is linked to the problem of mobility, which is increasingly recognized, since in the European community 80 percent of people and 50 percent of goods travel on the roads. And, by 2010, it is forecast that traffic will have increased by 40 percent.

A further system envisages the use of sensors embedded in the asphalt which measure the intensity and speed of the traffic flow. Other devices detect the meteorological conditions, visibility and the presence of ice on the road surface. The data permits a central processor to recognize and report the anomalies: accidents, slowing-moving traffic, fog banks. Panels with luminous diodes located at each kilometer and near the slip roads offer drivers up-to-date traffic information.

It is envisaged that, in the future, many roads will be monitored in this way. The information will be transmitted via radio to computers installed on-board the vehicles, capable of warning the driver of hazardous situations and, in the event of jams, indicating alternative routes.

In fact, computerized road navigation systems, which show the position of the car and the route to take to reach destination on an electronic map, have now moved on from the experimental phase. The computer, equipped with road maps memorized on a CD-Rom, registers every one of the car's movements using a compass and a precision odometer. At the moment it is switched on and at subsequent intervals, the processor compares the estimated position with that provided by the GPS satellite location system. Use of the electronic navigator is simple: it is sufficient to type in the destination and the system selects the shortest route. While the map runs over the screen (the car is represented by an arrow), a vocal synthesizer warns the driver when to take new roads.

With an on-board computer capable of receiving messages, many innovations already experimented by car manufacturers can be applied. Road signs, for example, could be backed up by the transmission of radio pulses. When a vehicle approaches a stop, the on-board computer warns the driver using a beeper and by projecting an image in front of his field of vision. Many efforts are aimed at preventing rear-end collisions. A car that brakes suddenly, a moment of distraction and often the impact is inevitable. In addition to what has been illustrated above, a system is being realized which permits vehicles to move at the same speed without ever getting too close to the car ahead, below the safe distance. This is a device which automatically maintains the speed set by the driver. The system intends to regulate the speed according to the traffic conditions. It is equipped, in fact, with an infrared laser radar, which recognizes the edges of the road, other vehicles and any obstacles. When the car gets too close to the one ahead, the systems stops the acceleration and, if necessary, also applies the brakes with a greater rapidity than our reaction times. Furthermore, it allows the car to follow the vehicle ahead, maintaining the same speed and the right distance. For driving in scarce visibility conditions, several solutions are being studied, such as infrared systems similar to those used in the Gulf War and synchronized light devices. And then there is radar. Radio waves are not obstructed by fog and therefore can provide an important contribution to safety in the winter months. Tests are being conducted on a radar for motor vehicles capable of scanning up to 160 meters and obtaining an electronic image of the road. Thanks to artificial intelligence techniques, the system distinguishes between the guardrail or trees and sudden obstacles, like vehicles, cyclists, pedestrians, and in the event of a hazard, warns the driver.

Everything illustrated above shows how widely recognized the need to reduce road accidents and improve road conditions and visibility is but all the diverse studies and signaling systems, whether in use or in the experimental phase, do not, however, solve the serious and thorny problem of visibility for drivers.

### DISCLOSURE OF INVENTION

The aim of the present invention is essentially to solve the aforesaid problems of the commonly known technique, overcoming the drawbacks described above by means of a visual device for vehicles in difficult climatic/environmental conditions able to identify obstacles even in reduced or zero-visibility conditions, permitting good diurnal vision in the presence of mist, fog, smoke or storms and excellent nocturnal vision.

A second aim of the present invention is to realize a visual device for vehicles able to permit the recognition of objects from considerable distances both in the daytime and at night.

A still further aim of the present invention is to realize a visual device for vehicles which consents a driver to see almost perfectly what is happening ahead of his vehicle in unfavorable climatic circumstances and situations, such as fog, even in the presence of extremely thick fog, allowing the driver the possibility of completely safe driving.

A still further aim of the present invention is to have a visual device for vehicles which is able to offer the driver a realistic visual representation of all the surrounding objects.

A still further aim of the present invention is to have a visual device for vehicles in difficult climatic/environmental conditions which consents the identification of maneuvers by vehicles from their initial phase.

A still further but not final aim of the present invention is to realize a visual device for vehicles in difficult climatic/environmental conditions which is simple to realize and functions well.

These aims and others beside, which will better emerge over the course of the present description, are essentially achieved by a visual device for vehicles in difficult climatic/environmental conditions in accordance with the claims that follow.

Further characteristics and advantages will better emerge in the detailed description that follows of a visual device for vehicles in difficult climatic/environmental conditions according to the present invention illustrated purely in the form of non-limiting examples in the plates enclosed, in which.

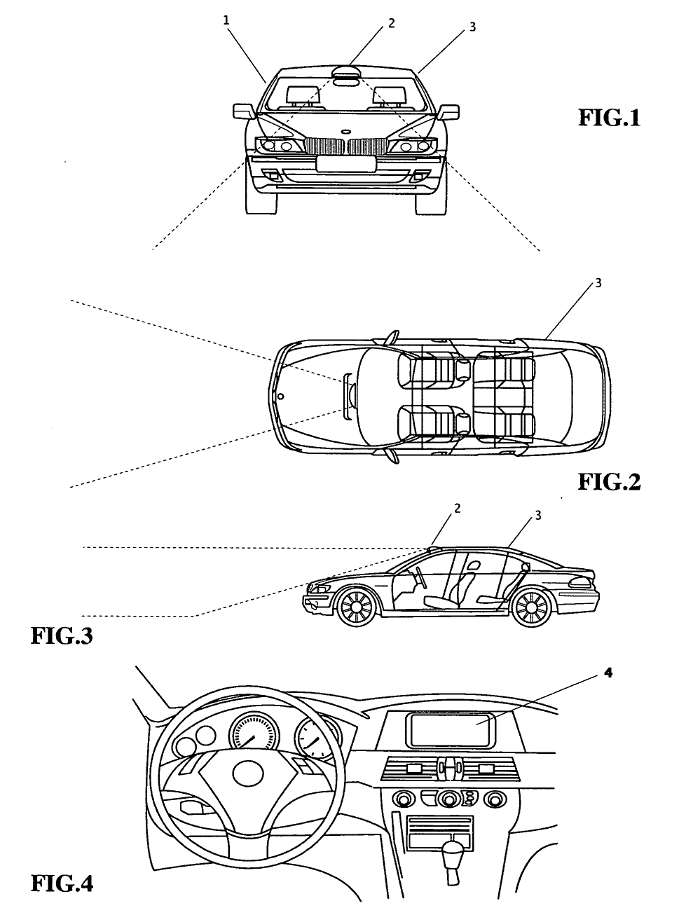

FIG. 1 shows, in a schematic front view, a visual device for vehicles in difficult climatic/environmental conditions as per the device in question in the present invention applied to a car.

FIG. 2 shows a schematic top view of the car with the visual device for vehicles from FIG. 1;

FIG. 3 shows a schematic lateral view of the visual device for vehicles from FIG. 1;

FIG. 4 shows the interior of a car equipped with the visual device for vehicles in question;

FIG. 5 shows the view of a road through the device according to the present invention;

FIG. 6 shows a different view of a road by means of the visual device in question;

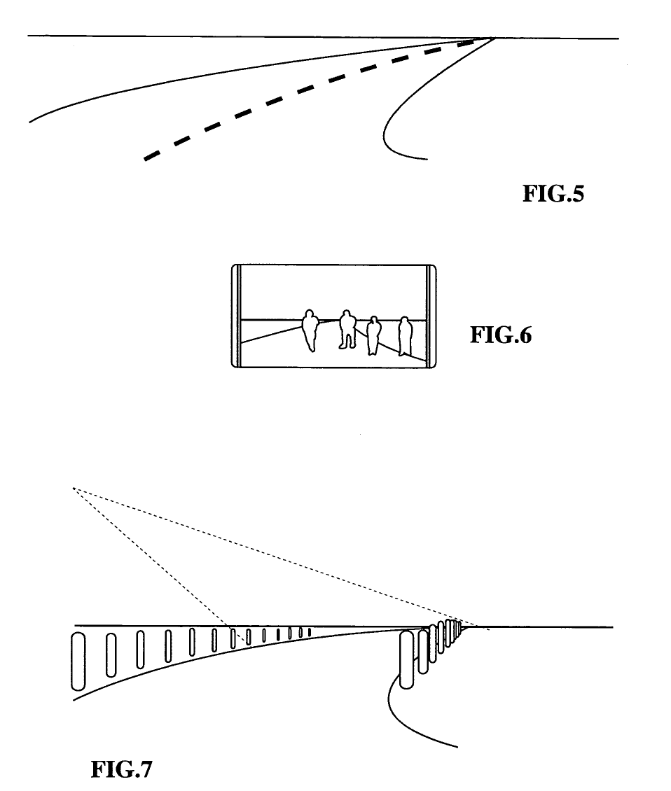

FIG. 7 shows a further view of a road;

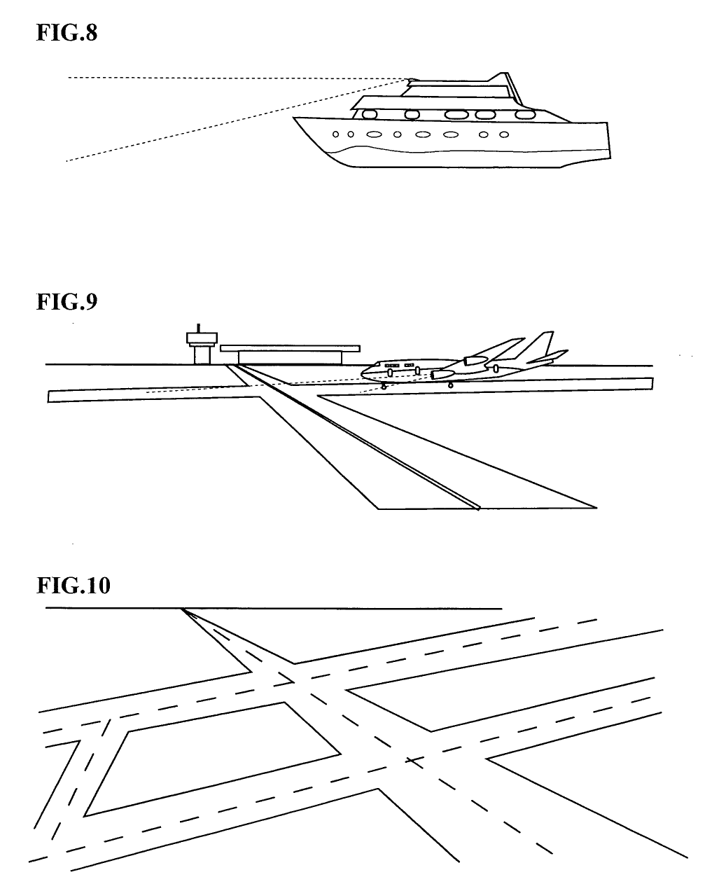

FIG. 8 shows a boat seen through the visual device;

FIG. 9 shows an airplane and a runway seen with the device with the presence of darkness and fog;

FIG. 10 shows a runway seen with the device in conditions of darkness;

With reference to the aforesaid figures, and in particular FIG. 1, 1 denotes the whole of the visual device for vehicles in difficult climatic/environmental conditions according to the present invention. The visual device for vehicles in difficult climatic/environmental conditions 1 is essentially constituted of a thermal camera 2 installed on a vehicle 3, as shown in FIGS. 1, 2 add 3, and positioned in the front central section of the vehicle, connected to a viewing means 4 positioned in the interior thereof, as shown in FIG. 4. In greater detail, the thermal camera can be housed in the centre of the vehicle, or at the top of the windshield or it can be moved laterally depending on the driver's position and, however, in such a way as to allow a complete view of the road carriageway. Furthermore, the thermal camera presents a suitable protective structure to prevent accidental breakage, damage or theft.

In particular, the thermal camera's connection to the viewing means 4 is realized by means of a coaxial or fiber optical cable.

The viewing means 4 is constituted of a video display and, similarly, a TV system can be utilized if already fitted on the vehicle, as long as it is visible to whoever is driving. Alternatively, the viewing means is constituted of a wireless monocular viewer which utilizes a standard, substantially known communication protocol to interact with the thermal camera and to provide mobile observations. Aforesaid wireless viewer can be mounted on spectacles and provide a digital quality image. In particular, the viewer, which proves extremely light (weighing just 28 g), is fixed quickly to a special support.

Alternatively, for people who wear spectacles, a second type of monocular viewer is possible, which proves extremely practical and convenient as it can be placed directly on top of the spectacles. The second viewer functions with a small, lightweight battery, is easily fixed on, and can be transported inside one's pockets.

According to the present invention, one variant to the use of aforesaid video display is that of a second display which permits color vision, is completely programmable and able to project the driving and traffic information and the navigation information onto the windshield.

This system offers undeniable advantages in terms of safety for drivers who, this way, do not have to lower their gaze from the road to check the image on the display, consequently reducing the occasions for the driver to be distracted. In fact, while drivers take circa one second to read the information on the dashboard—exactly the time it takes to cover 14 meters at a speed of 50 km/h—the second display would halve this time. A still greater difference in time is required by older drivers, who are less accustomed to adjusting their sight to different distances.

In greater detail, said display functions as follows: a powerful light source transmits a white light (with a luminosity of 500,000 candles per m2) which is deflected by a reflector towards an ultra flat, color, liquid crystal display, with a definition of 65,000 pixels. The rays of light originating from the source reach the windshield by means of diverse mirrors which serve to compensate for the curving thereof. It is also possible to regulate the superimposed image on the basis of the driver's position.

The system's central unit is situated in the passenger compartment, behind the dashboard, and the image produced is reflected onto the windshield.

The driver, however, does not see the image on the surface of said windshield, seeing it instead on the dashboard, from a distance of approximately 2 meters. In this way, the adjustment time needed by the eye to see objects located at difference distances clearly is reduced.

In addition to what has been illustrated above, the viewing means 4 can be constituted of other devices which allow images to be seen or sound signals to be received derived from the images transmitted by the thermal camera.

In agreement with the present invention, a thermal image system helps the human eye to see better in daylight, during the night and, above all, in the presence of fog. The thermal camera, not only permits the driver to see in total darkness, it also permits objects to be identified, such as people, animals and vehicles, in any luminosity condition. As they perceive heat, thermal cameras have a vaster field of application than devices which intensify nocturnal light, such as X-rays, given that they operate with a sensor constituted of a two-dimensional microbolometric matrix operating within the atmospheric window (8-14 mm), without a cooling system and with a frame rate of 50 or 60 Hz.

Although thermal cameras, sometimes, do not have the same resolution as devices which intensify nocturnal light, they offer a detailed image, as shown in FIGS. 5, 6 and 7, even in conditions which are not exactly ideal as they utilize an optical system with germanium lenses. This happens because the thermal camera does not need visual contrast to discern objects. While fog and other forms of precipitation degrade nocturnal intensification images, thermal cameras can see through fog, mist, clouds, smoke, rain and even many mimetic structures. People, equipment and other objects can be separated from confused backgrounds and from foliage and one example is illustrated in FIG. 6. Thermal cameras can provide information on the environment that would never be available with any degree of amplification, as shown in FIGS. 5 and 7. Thermal cameras offer drivers, therefore, the possibility to see obstacles from a greater distance than those given by devices based on image intensification. The range of detection depends on the size of the object and the thermal contrast, therefore, generally speaking, the system permits the driver to identify another vehicle or a person from a distance of circa 700 meters or more.

Thermal cameras are not susceptible to luminosity, are not dazzled and do not switch off, as happens with devices which intensify nocturnal light when they are exposed to an intense light, since they do not detect light but infrared energy.

In addition, thermal cameras are independent of all light sources since they identify and amplify electromagnetic energy emitted as irradiated heat by all living organisms and by the majority of machines, even in the hours after they are switched off.

This type of infrared radiation is invisible to the naked eye, however, thermal image systems render it visible and detectable by means of a sensitive circuit which converts energy into a visible form supplying, as a consequence, the image of the source of radiation. Even the slightest difference in temperature, less than 0.1° C., is detected and converted into standard video signals. With this level of sensitivity, the instrument is able to identify objects quite some distance away.

In addition to what has been illustrated above, the visual device according to the present invention can be supported by a thermal signaling device which can be positioned on the sides of the carriageway and fixed to supports or posts, including existing ones, instead of or beside the current cats' eyes or positioned along the length of the white line painted on the asphalt. The thermal signaling device produces heat with an average temperature of 4° C. and can be identified with a thermal camera mounted on vehicles, permitting a precise delimitation of the road bed, as shown in FIG. 7. The thermal signaling device emits high levels of energy crossing the entire spectrum of the thermal detector, thus aiding long-range identification.

To the naked eye, the device appears to be a normal coupling, or cats' eye but, as soon as it is activated, it is identified by the thermal instruments as an extremely luminous and hot spot, which permits the route to be identified. Furthermore, its additional use at the centre of the road on the median line determines the limit of its own carriageway so as to prevent anomalous carriageway crossings which could cause accidents. In particular, thermal signaling devices could also be utilized in airports and ports for identifying routes and obstacles to airplanes maneuvering on the runway or boats in ports and airplanes and boats equipped with thermal cameras.

In fact, by equipping said vehicles with the visual device according to the present invention, it is possible to facilitate landing or take-off operations for airplanes, in spite of the presence of current flying systems, since, in adverse climatic conditions, the pilot would not find himself flying blindly, as he would be able to see the runway and its surroundings. Similarly, the presence of the visual signaling device would allow boats to accomplish maneuvers safely since they would see any obstacles or other boats, in addition to being able to have lanes marked for navigation, especially in zones with navigation difficulties such as, for example, the Venice lagoon.

After this predominantly structural description, there follows a description of the functioning of the invention in question.

When a user find himself forced to drive in difficult visual conditions due to fog, smoke, storms or darkness, it is sufficient to switch on the visual device and, by means of the thermal camera, watch the images that are reproduced on the video display or by means of the monocular viewer or which are projected onto the windshield to find out exactly what is ahead of the vehicle, in terms of both Obstacles and delimitations of the road's carriageway.

Thus, the present invention achieves the aims set.

In fact, the visual device for visual device for vehicles in difficult climatic/environmental conditions is able to identify obstacles even during even in reduced or zero-visibility conditions, permitting good diurnal vision in the presence of mist, fog, smoke or storms, and excellent nocturnal vision.

Furthermore, the visual device is able to permit the recognition of objects from considerable distances both in the daytime and at night, and to permit the driver see, almost perfectly, what is happening ahead of the vehicle in unfavorable circumstances and situations, such as fog, even in the presence of very thick fog.

Advantageously, the visual device according to the present invention offers the driver the possibility to drive safely with a realistic visual representation of all the surrounding objects.

Further more, the visual device consents the identification of maneuvers by other vehicles or of anomalous movements, from their initial phase.

A further advantage offered by the visual device in question derives from the fact that the driver is assisted in his driving and his control of the vehicle, permitting him to follow and maintain a correct vehicle trajectory on the road and to see what is ahead of the vehicle so as not to cause accidents or be involved in existing accidents, since s/he is able to modify the speed and direction of the vehicle in time.

In addition to what is stated above, the visual device contributes to greater traffic safety and to saving lives, unlike what happens with the commonly known technique.

Furthermore, the visual device can also be utilized on boats and airplanes and be used together with the thermal signaling device to identify ports and hazardous routes and runways in order to be able to accomplish maneuvers, mooring, landings or take-offs safely, even in adverse climatic conditions and in the absence of light.

Advantageously, the visual device in question proves easy and quick to use, practical and very versatile.

A still further but not final advantage of the present invention is that it proves notably easy to use, simple to realize and functions well.

Naturally, numerous modifications and variants can be applied to the present invention while still remaining within the scope of the invention as claimed herein.

1) A visual device for vehicles in difficult climatic/environmental conditions characterized by the fact that said device is essentially constituted of a thermal camera (2) installed on a vehicle and connected to a viewing means (4) positioned in the interior thereof, by means of a connection cable, said visual device being designed to operate from a resting condition in which it proves inactive, with no image present on the viewing means, to an operative condition in which a driver sees what is happening ahead of his own vehicle.

2) A visual device for vehicles in difficult climatic/environmental conditions according to claim 1 characterized by the fact that said thermal camera (2) is housed in the centre of the vehicle, either at the top of the windshield or positioned laterally, depending on the driver's position.

3) A visual device for vehicles in difficult climatic/environmental conditions according to claim 1 characterized by the fact that said thermal camera (2) presents a protective structure.

4) A visual device for vehicles in difficult climatic/environmental conditions according to claim 1 characterized by the fact that the connection of said thermal camera (2) to the viewing means (4) is realized by means of a coaxial or fiber optic cable.

5) A visual device for vehicles in difficult climatic/environmental conditions according to claim 1 characterized by the fact that said viewing means (4) is constituted of a video display.

6) A visual device for vehicles in difficult climatic/environmental conditions according to claim 1 characterized by the fact that said viewing means (4) is constituted of a monocular viewer.

7) A visual device for vehicles in difficult climatic/environmental conditions according to claim 1 characterized by the fact that said viewing means (4) is constituted of a second display which is able to project the images onto the windshield.

8) A visual device for vehicles in difficult climatic/environmental conditions according to claim 1 characterized by the fact that said visual device is supported by a thermal signaling device which can be positioned on the sides of the carriageway and fixed to supports or posts, or positioned along the length of the white line painted on the asphalt.

9) A visual device for vehicles in difficult climatic/environmental conditions according to claim 8 characterized by the fact that said thermal signaling device can be positioned on an airport runway.

10) A visual device for vehicles in difficult climatic/environmental conditions according to claim 8 characterized by the fact that said thermal signaling device can be positioned so as to delimit a port or navigation channels for guiding boats.
